(19) United States
(12) Patent Application Publication
(10) Pub. No.: US 2018/0012602 A1
(43) Pub. Date: Jan. 11, 2018

(54) SYSTEM AND METHODS FOR PRONUNCIATION ANALYSIS-BASED SPEAKER VERIFICATION

(71) Applicants: Julia Komissarchik, Draper, UT (US); Edward Komissarchik, Draper, UT (US)

(72) Inventors: Julia Komissarchik, Draper, UT (US); Edward Komissarchik, Draper, UT (US)

(21) Appl. No.: 15/641,294

(22) Filed: Jul. 4, 2017

Related U.S. Application Data
(60) Provisional application No. 62/359,642, filed on Jul. 7, 2016.

(51) Int. Cl. G10L 17/24; H04L 29/06; G10L 17/04; G10L 17/02; G10L 17/06; G10L 15/30; H04W 12/06

(52) U.S. Cl. CPC G10L 17/24; G10L 17/06; H04L 63/0861; G10L 15/30; G10L 17/04; G10L 17/02; H04W 12/06

(57) ABSTRACT

A system and method for speaker verification based on using N-best speech recognition results.

### FIELD OF THE INVENTION

The present invention relates generally to the field of speaker verification and particularly to a system of verification of speakers based on an analysis of their pronunciation patterns.

### BACKGROUND OF THE INVENTION

Voice-based communication with an electronic device (computer, smartphone, car, home appliance) is becoming ubiquitous. With the dramatic growth of voice-enabled devices, the problem of speaker verification has moved to the mainstream. Many devices, especially in Internet of Things world, are so small that the only way to communicate with them that is convenient to a human is through voice commands. These devices, typically controlled from a distance, can become a serious security risk, especially by the fact that they are not just sensors that collect data but can execute actions. Voice enabled banking is another big area where speaker authentication is important.

Typical speaker verification system uses the following processes: user enrollment procedure that includes collection of user speech samples for preselected phrases and context data to be used for verification; user verification procedure part A, when a user is asked to pronounce one or several phrases from the list of phrases used during enrollment; and user verification procedure part B, when a user is asked to pronounce one or several new challenge phrases.

The enrollment speech samples are used to extract features from user speech to be compared with features extracted during user verification processes. Additionally, recordings of user voice during other interaction with the system can also be used for feature extraction. What features are extracted vary from system to system and can include acoustic, phonetic and prosodic aspects of speech. Context data (e.g. favorite color) can be used to improve imposter detection.

There are two major problem to be addressed in speaker verification: ability to discern an imposter (low false positive rate); and stability (low false negative rate) of recognition of a user across different microphones, noise conditions and different ways a user can speak from one day to another.

The false positive problem is exacerbated by an automatic attack when a recording of user speech is played back to the system. This particular problem is typically addressed by using new phrases in the verification process that were not used during enrollment. The difficulty of using new phrases is that the feature set the system uses to do the verification should be phrase independent, and that is not easy to design. Therefore, some system designers try to build new phrases from the parts of known phrases (see, for example, Google's U.S. Pat. No. 8,812,320). Though potentially this approach can be useful, speech concatenation is a quite complex issue. For example, the mentioned patent uses a challenge word “peanut” based on the enrollment word ‘donut’, and if it does not work uses a challenge word “chestnut”. However transitions from T to ‘n’ in ‘peanut’ and ‘t’ to ‘n’ in ‘chestnut’ are quite different than that from ‘o’ to ‘n’ in “donut’ and can cause differences in features used for verification. The use of standalone word ‘nut’ does not solve the problem either, since aspiration at the beginning and at the end of isolated words introduces additional challenges to stable feature extraction.

However, the problem of stability (low false negative rate) is even more challenging. Features extracted from one effort of user pronouncing a phrase can be quite different from features extracted from a different effort to pronounce the same phrase by the same user. Some researchers tried to use certain parameters that can be extracted from speech that indicate anatomical characteristic of user's vocal apparatus, the size of user's head, etc. (see, for example, U.S. Pat. No. 7,016,833). However, the majority of researchers use acoustic, phonetic parameters that are typically used for speech recognition. This is not necessarily the best way, since the purpose of speech recognition is to find out what was said, while the purpose of speaker identification is to find out who said it. The corresponding features thus suffer from ASR “bias” to recognize the phrase and not the speaker. On phonetic (and prosodic) level it leads to use of forced alignment of the phoneme boundaries even if the speaker did not pronounce certain phonemes or pronounced parasitic phonemes, and thus changed the prosodic structure of the utterance. To some extent, the problem of speaker verification is more akin to pronunciation training, since it is interested in not necessarily what was said, but how.

In view of the shortcomings of the prior art, it would be desirable to develop a new approach that can determine certain user speech peculiarities that can be reliably found in user's speech samples and use them to distinguish a legitimate user from an imposter, when, suddenly, what was difficult for a legitimate user to pronounce, was pronounced correctly, and what was easy for a legitimate user to pronounce, was pronounced incorrectly.

It further would be desirable to provide a system and methods for detecting such stable patterns and use them to detect if a speaker is a legitimate user or an imposter.

It still further would be desirable to provide a system and method to build challenge phrases for speaker verification that construct challenge phrases based on a particular user's pronunciation peculiarities.

It still further would be desirable to provide a system and methods for speaker verification that can use any third party automatic speech recognition system and work in any language that ASR handles.

### SUMMARY OF THE INVENTION

The present invention is a system and method for pronunciation analysis-based speaker verification to distinguish a legitimate user from an imposter.

In view of the aforementioned drawbacks of previously known systems and methods, the present invention provides a system and methods for detecting stable speech patterns of a legitimate user and using these individual speech patterns to build a set of challenge phrases to be pronounced at the speaker verification phase.

This patent looks at the problem of speaker verification from a different angle. It does not assume that user will pronounce phrases correctly, but looks for stable speech patterns that can be reliably expected in user's speech. Incorrect pronunciation of certain words/phrases or phoneme sequences (as soon as it is consistently incorrect) is quite useful to detect an imposter.

The approach of this invention is to determine certain user speech peculiarities that can be reliably found in speech samples of a particular user. This approach uses the concept of pronunciation “stars” described in the U.S. Pat. 9,076,347 (which is incorporated here by reference). These stars are generated by the analysis of N-best speech recognition results from samples of user speech. There are two major advantages of this approach—it can work with any ASR and it can be used for any language. The methods described in this patent are applicable to the problem of ability to discern an imposter or an automated attack (low false positives) and stability (low false negatives).

The present invention further provides mechanisms to build challenge phrases to be used during speaker verification/authentication that are based on (correct and incorrect) stable speech patterns of a legitimate user.

In accordance with one aspect of the invention, a system and methods for speaker verification/authentication are provided wherein the response of a publicly accessible third party ASR system to user utterances is monitored to detect pronunciation peculiarities of a user.

In accordance with another aspect of the invention, the system and methods for automatic verification of a speaker is provided based on correct and incorrect stable pronunciation patterns of a legitimate user.

This invention can be used for verification/authentication of different types of users including ones that have speech impediments or heavy regional accents.

Though some examples in the Detailed Description of the Preferred Embodiments Invention and in the Drawings are referring to English language, the one skilled in the art will see that the methods of this invention are language independent and can be applied to any language and can be used in any speaker identification system based on any speech recognition engine.

### BRIEF DESCRIPTION OF THE DRAWINGS

Further features of the invention, its nature and various advantages will be apparent from the accompanying drawings and the following detailed description of the preferred embodiments, in which:

FIGS. 1 and 2 are, respectively, a schematic diagram of the system of the present invention comprising software modules programmed to operate on a computer system of conventional design having Internet access, and representative components of exemplary hardware for implementing the system of FIG. 1.

FIG. 3 is a schematic diagram of aspects of an exemplary speech analysis system suitable for use in the systems and methods of the present invention.

FIG. 4 is a schematic diagram of aspects of an exemplary star repository suitable for use in the systems and methods of the present invention.

FIGS. 5a and 5b are schematic diagrams depicting examples of word and phoneme stars from an exemplary embodiment of star repository suitable for use in the systems and methods of the present invention.

FIG. 6 is a schematic diagram of aspects of an exemplary challenge phrase generation system suitable for use in the systems and methods of the present invention.

FIG. 7 is a schematic diagram of aspects of an exemplary verification system suitable for use in the systems and methods of the present invention.

### DETAILED DESCRIPTION OF THE PREFERRED EMBODIMENTS

Referring to FIG. 1, system 100 for pronunciation analysis-based speaker verification is described. System 100 comprises of a number of software modules that cooperate to detect stable pronunciation patterns of a user (correct and incorrect), detect typical errors of ASR for multiple users, build pronunciation pattern-dependent challenge phrases for speaker verification for individual user and for group of users and perform verification of a speaker as a user or as an imposter.

In particular, system 100 comprises of automatic speech recognition system (“ASR”) 101, utterance repository 102, performance repository 103, star repository 104, speech analysis system 105, star generation system 106, enrollment repository 107, enrollment system 108, challenge phrase repository 109, challenge phrase generation system 110, verification system 111, and human-machine interface component 112.

Methods to build some of these systems were introduced in U.S. Pat. 9,076,347 patent application Ser. No. 15/587,234, patent application Ser. No. 15/592,946 and patent application 15/607,568 (which are incorporated here by reference).

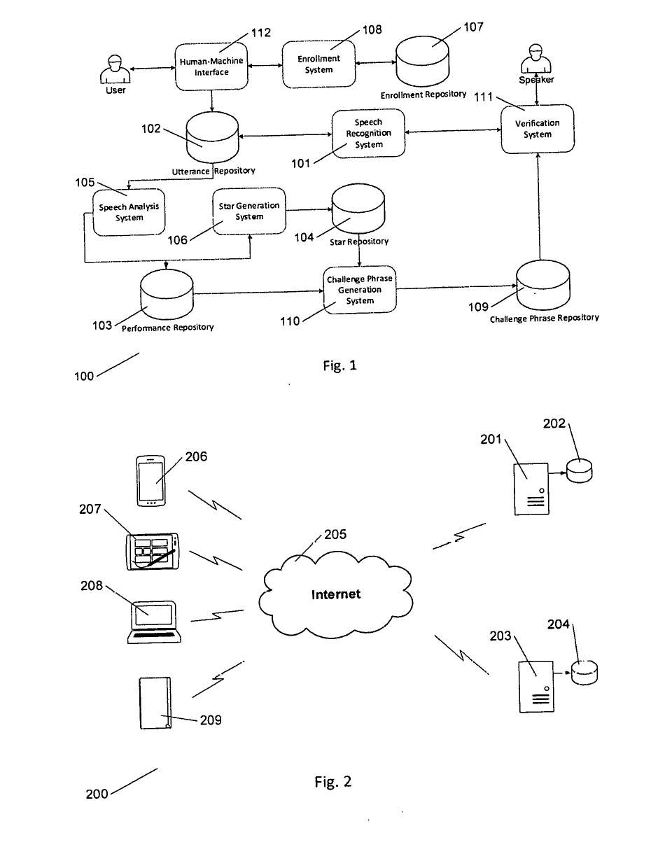

Components 101-112 may be implemented as a standalone system capable of running on a single personal computer. More preferably, however, components 101-112 are distributed over a network, so that certain components, such as repositories and systems 102-111 and ASR 101 reside on servers accessible via the Internet. FIG. 2 provides one such exemplary embodiment of system 100, wherein repositories and systems 102-111 may be hosted by the provider of pronunciation analysis-based speaker verification software on server 201 including database 202, while ASR system 101, such as Google Voice system, is hosted on server 203 including database 204. Servers 201 and 203 are coupled to Internet 205 via known communication pathways, including wired and wireless networks.

A user using the inventive system and methods of the present invention may access Internet 205 via mobile phone 206, via tablet 207, via personal computer 208, or via speaker verification control box 209. Human-machine interface component 112 preferably is loaded onto and runs on mobile devices 206 or 207 or computer 208, while utterance repository 102, performance repository 103, star repository 104, speech analysis system 105, star generation system 106, enrollment repository 107, enrollment system 108, challenge phrase generation system 110 may operate on server side (i.e., server 201 and database 202 correspondingly), while challenge phrase repository 109 and verification system 111 may operate on server side together with ASR 101 (i.e. database 204 and server 203 correspondingly), depending upon the complexity and processing capability required for specific embodiments of the inventive system.

Each of the foregoing subsystems and components 101-112 are described below.

Automatic Speech Recognition System (ASR)

The system can use any ASR. Though multiple ASRs can be used in parallel to process user's speech, typical configuration consists of just one ASR. A number of companies (e.g. Google, Nuance and Microsoft) have good ASRs that are used in different tasks spanning voice assistance, IVR, web search, navigation, voice commands. Most ASRs have Application Programming Interfaces (API) that provide details of the recognition process including alternative recognition results (so called N-Best list) and in some cases acoustic features of the utterances spoken. Recognition results provided through API in many cases are associated with weights that show level of confidence that ASR has in each particular alternative.

Utterance Repository

Utterance repository 102 contains users' utterances and ASR results. This repository is used to store utterances collected during user enrollment, as well as utterances user uttered during verification. For the latter, they are stored only if the verification process confirmed the identity of the user. Additionally, in some cases other samples of user speech are available. For example, when a user communicates with IVR user's speech is recorded (with user's consent), and can be stored in the utterance repository 102. For each utterance stored in the repository, the following information can be stored:
Text that the user was supposed to utter
Recording of the utterance
Acoustic features of the utterance
Alternative parameters such as confidence level, position in the N-Best list Usually only utterances with at least one alternative with high confidence level are stored. The utterances that have low confidence level even for the best recognition alternative typically are too garbled to be useful or meaningful for speaker verification.

Performance Repository

Performance repository 103 contains historical and aggregated information on user pronunciation. The performance repository 103 can contain the following information:
History/Time Series of recognition of individual phonemes, words and collocations
Comparative recognition results of difficult (for user) words/phrases to pronounce
Comparative recognition results of easy (for user) words/phrases to pronounce
History/Time Series of speech disfluencies
This repository is used to determine patterns of user pronunciation to be used at speaker verification stage. If certain phonemes, sequence of phonemes, words or phrases were difficult for a user, and, suddenly, a speaker can pronounce them well during verification, then it is quite likely that he is an imposter. The same is true if the user stumbles at verification stage with pronunciation of certain phonemes, words or sentences he/she never had difficulties with before. Stable patterns that can be indicative for verification are stored in star repository 104.

Star Repositorty

Stars were introduced in the U.S. Pat. No. 9,076,347 mentioned above. Star is a structure that consists of a central node and a set of periphery nodes connected to the central node. Central node contains phoneme, sequence of phonemes, word or phrase that was supposed to be pronounced. Periphery nodes contain ASR recognition of the pronunciation of the central node by a user or a group of users. Stars contain aggregate knowledge about user pronunciation patterns, and are used to check if user pronunciation during verification stage matches these patterns.

Speech Analysis System

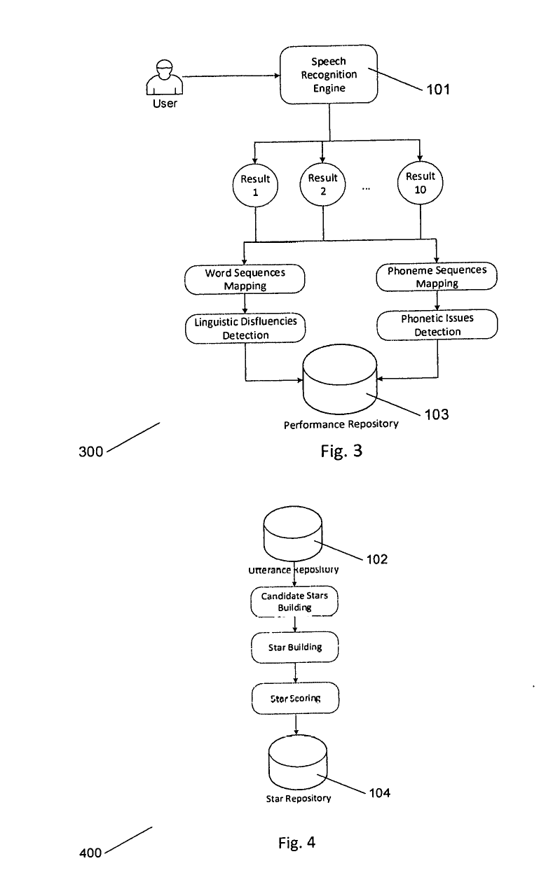

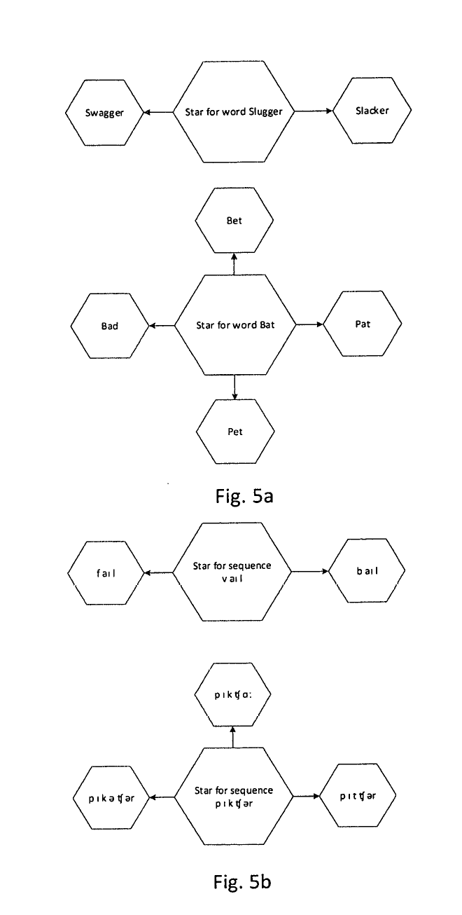

Referring now to FIG. 3, the speech analysis system 105 analyses ASR results. This system analyses ASR results both in cases when it is unknown what phrase was pronounced or supposed to be pronounced by a user (Unsupervised Analysis) and in cases when a user is supposed to pronounce a phrase from a predefined list (Supervised Analysis). The unsupervised situation is atypical for speaker verification system. However, if a set of prerecorded user utterances is available it can be applied. For detailed description of both unsupervised and supervised speech analysis, see patent application Ser. No. 15/587,234.

Star Generation System

Referring now to FIG. 4, the star generation system 105 uses performance repository 103 to find sequences of phonemes, words and phrases that have homogeneous N-best results in multiple occurrences in one utterance and across multiple utterances. While in U.S. Pat. No. 9,076,347 the central node of a star contained a word or a phrase, in this patent it can also be a sequence of phonemes. The results are stored in star repository 104. The stars for a particular user are updated when utterance repository 102 gets additional utterances from that user.

Star Building Algorithm

Star Building algorithm uses as its input the results of word matching and phoneme matching subsystems of speech analysis system 105. In most cases, the phrase to be pronounced is known, so the supervised version of the matching algorithms is used. In cases when it is not known (e.g. if a corpus of user utterances was collected during interaction with IVR) then the top ASR result with very high confidence can be used as a substitute.

For each utterance, a set of candidate stars is built. Nodes in each candidate star are the subsequences of words (or phonemes) that occurred in high confident portion of N-Best results of recognition of this particular utterance. The central node contains the subsequence of words (or phonemes) from a phrase that was supposed to be pronounced, while periphery nodes contain corresponding subsequences from N-best results. To increase reliability of stars only those subsequences are used for the central node that consist of two matched intervals with one gap in between or one matched interval with one gap before or one gap after. The sequence of words (or phonemes) in the central node of one star can be a subset of the sequence from the central node of another star. However, sequences with, multiple gaps can also be used.

After candidate stars are built for each utterance of a particular user, aggregated stars are built as a union of candidate stars that have the same central sequence of words/phrases (or phonemes). The weight of each ray (from central node to a periphery node) is calculated as a combination (e.g. a weighted sum) of the corresponding rays from candidate stars.

An aggregate star is being promoted to the status of a star if it has a small number of rays with high confidence level. The thresholds that determine the meaning of the word ‘small’ depend on quality of ASR and the richness of the set of utterances available from a user.

The stars then are stored in the star repository 104. Candidate stars are also stored in the star repository 104, since they are used in the star update process later when new user utterances are collected. The aggregated stars that did not become stars however are discarded since the weights of their rays are calculated using not necessarily additive functions.

Enrollment Repository

Enrollment repository 107 contains information about phrases to be used for the enrollment process. This repository also can contain context information that can be used for user verification, including information such as favorite pet, favorite color, or mother's maiden name. The phrases for the user to pronounce during enrollment should be representative enough to cover different aspects of pronunciation including phoneme coverage. There are a number of sources to get these phrases from. One example is a set of phrases used to build one of the first speech corpora—TIMIT. TIMIT was built by a combined effort of Texas Instrument and Massachusetts Institute of Technology in early 1980's and contains hundreds of phrases that were pronounced by hundreds of speakers in the USA with different regional accents. Use of TIMIT and collections like that provides a solid foundation for a choice of stable word and phoneme sequences to be used for verification, thus allowing to collect corresponding user samples during enrollment. Two special phrases were pronounced by all speakers involved in TIMIT construction. These two sentences contain all English phonemes and thus provide additional solid foundation for choice of phoneme sequences for enrollment and verification.

Enrollment System

Enrollment system 108 is designed to collect user pronunciation samples, and extract features to be used during verification when user tries to access different applications using voice-based interface. Since in many cases enrollment is done through voice communication with the user, enrollment system could also use additional data elements such as last four digits of SSN, date of birth, or mother's maiden name. These data elements could be either collected during enrollment or inputted from other systems. The latter case is typical for voice-enabled banking.

Challenge Phrase Repository

Challenge phrase repository 109 contains phrases that are used during speaker verification. These phrases are presented to a speaker and then the results are matched against the stored profiles of the speaker (see the description of verification system 111 below). Though the same phrase can be used for multiple speakers (as what typically is done by speaker verification systems), the more robust approach is to use phrases that are tuned to individual speaker pronunciation peculiarities (see the description of challenge phrase generation system 110 below). The presence of these peculiarities is an indicator that the speaker is not an imposter, while their absence is an indicator of a potential imposter. An interesting phenomenon is that the opposite is also true. If in pronouncing a challenge phrase a speaker utterance have peculiarities that were not present during enrollment, then it is an indicator for this speaker being an imposter.

Challenge Phrase Generation System

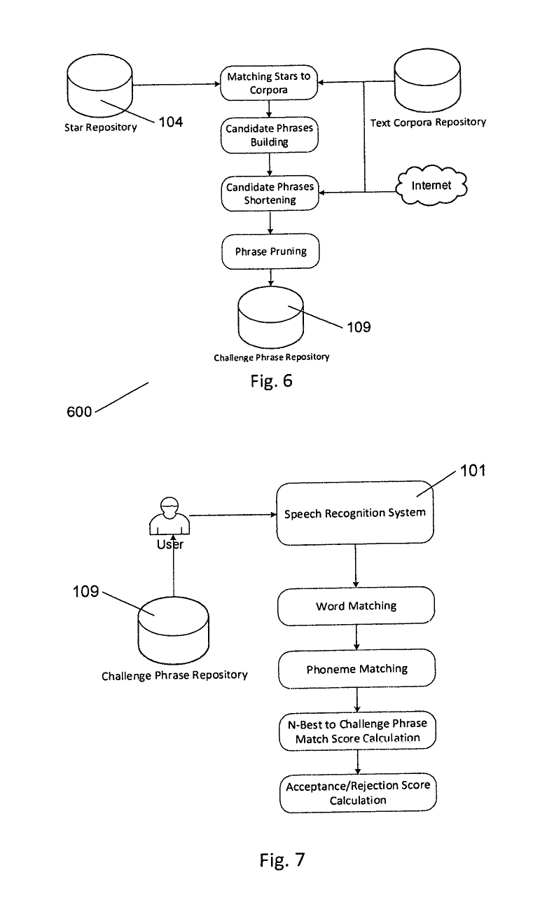

Referring now to FIG. 6, challenge phrase generation system 110 builds phrases to be used during speaker verification. For each user it creates two sets of challenge phrases. Type 1-phrases that are similar to the central nodes in the stars for this user from the star repository 104 which have no more than 2 rays with weights above certain threshold. And Type 2-phrases that are similar to the central nodes in the stars from the star repository 104 that have 5 or more rays above that threshold. The first set is used to verify that the user can still pronounce well what he could pronounce during enrollment (or during other times of talking, for example, to an IVR), while the second one is used to detect an imposter if these phrases suddenly started to be well recognized. The results are stored in the challenge phrase repository 109. The results for a particular user are updated when the utterance repository 102 gets additional utterances from that user.

Challenge Phrase Generation Algorithm

The challenge phrase generation algorithm can use as its starting point any good text corpora. It can be, for example, Wall Street Journal or Tree Bank-corpora being used for speech and natural language processing research and testing. Alternatively, it can be sources like Wikipedia.

For each user the goal is to get some phrases or sub-phrases from chosen corpora that match the phrase in the central nodes of one star or a sequence of stars for that user from the star repository 104. Only stars with the number of rays over certain threshold that is 1 or 2 (Type 1) or 5 or more (Type 2) are chosen. For each chosen star matches of the phrase from the central node to the corpora are built. Sentences from the corpora that contain these phrases are candidates for the challenge phrases. The preference is given to the sentences that match several phrases from the stars of the same type. To choose which candidate phrases are to be used as challenge phrases, several considerations can be used. For example, they can be shortest possible ones (not to put too much burden on the user) or they can be the ones that contain at least 2 or even 3 non-overlapping matches to the stars, etc. Also, additional shortening of the challenge sentence can be achieved by lopping off the interval before the first match and after the last match for sentences that match more than one star. Furthermore, certain gaps between matched intervals in the sentence can be shorten or even eliminated. However, this action can break the grammar of the sentence, so grammar checker should be applied to eliminate badly formed phrases.

There is also a possibility to build challenge phrases artificially using phrases from the stars as building blocks. However, artificial phrases can be not in sync with the ASR language models and thus can distort recognition results, which makes verification process less reliable. It is always a possibility to use individual words from the phrases. However, it will also disturb the ASR results since individual words are pronounced differently when they are isolated and when they are part of a phrase.

The chosen challenge phrases are stored in challenge phrase repository 109 to be used during verification. Each challenge phrase is stored with the list of star id's that it was matched with, and parameters of the match.

Another approach to shorten the length of the challenge phrase is to extract noun phrases from the sentence and choose smaller ones provided they contain segments that match stars. That can be done using NLP parsers. Even more convenient way to extract smaller but still grammatically correct phrase is to use corpora like Tree Bank that already have sentences parsed.

The process just described is applied also to the stars where the central node contains not a phrase but a sequence of phonemes. The difference is that the match is done not to the words in corpora but to their phonetic representations using, for example, International Phonetic Alphabet. If the sequence of phonemes in the star has a beginning marker it can be matched only to the beginning of the word in the sentence from corpora, and correspondingly only to the end of the word if there is an end marker present.

The challenge phrases are associated with the score. The higher the score the more telling is the fact that during verification speaker pronounced them as the user or not. To calculate the score for Type 1 and Type 2 stars, stars for a particular user are matched to each other using phoneme matching system (see the patent application Ser. No. 15/587,234). Each sequence of phonemes with 3 or more phonemes in it is given a score equal to the number of times the sequence occurred in all these stars. The phrases' scores are equal to the weighted sum of scores of phoneme sequences that occur in them.

Verification System

Referring now to FIG. 7, verification system 111 uses challenge phrases of both type 1 and type 2 from the challenge phrases repository 109 corresponding to a particular user (or a category of users this user belongs to) and through user interface (see the description of human-machine interface system 112 below) asks a speaker (that pretends to be this user) to pronounce one or several phrases. The preference can be given to phrases with higher scores.

For each utterance, the results of recognition are compared with the stars corresponding to the pronounced phrase and match score is recorded. This is done for type 1 and type 2 separately. High score for a challenge phrase of type 1 is a sign that the speaker is not an imposter, while high score for type 2 is a sign that he is. Depending on each score and thresholds used in the definition of the term ‘high’ for each type, one or several more challenge sentences might be needed to decide if the speaker is the user he claims to be.

Challenge Phrase Pronunciation Scoring Algorithm

The challenge phrase pronunciation scoring algorithm takes ASR N-best results for pronounced challenge phrase from the challenge phrase repository 109 and calculates the total score of matching the challenge phrase to the stars associated with it using the following process:
Word matching algorithm (see the description of the speech analysis system 105 above) is applied to N-best results for pronounced challenge phrase and is used to match to stars that have a sequence of words in its central node
Phoneme matching algorithm (see the description of the speech analysis system 105 above) is applied to N-best results for pronounced challenge phrase and is used to match to stars that have sequence of phonemes in their central node
Then, for each “associated” star that is associated with the challenge phrase match to the phrase, a segment that corresponds to the match between a star and challenge phrase is “cut out” and a “challenge” star is built based upon all paths from the matching algorithm result
Then the score of matching a challenge star with associated star is calculated. One of the ways to calculate it is as a weighted sum of weights of common rays minus some penalty constant times the weight of a high confidence ray from challenge star that is not present in associated star
The score of the total match can be calculated as a weighted sum of scores of matches to each associated star.

Human-Machine Interface System

The human-machine interface system 112 is designed to facilitate communication between a user and the system. The system 112 can additionally use non-voice communication if the interaction setup provides for that (e.g. in case of a kiosk). However, for the speaker identification purposes the system can be configured to use just voice. In many cases, enrollment process can include non-voice communication, while verification process is typically voice only.

One of the possible configurations can include IVR which is de facto today's standard of consumers communication with companies. The static portion of interaction (greetings and instruction phrases) are usually pre-recorded and use human voice to make interaction more pleasant. For dynamic part of the interaction, the system uses text-to-speech. This is especially important for challenge phrases since they can be completely arbitrary.

The system 112 is also used to convey the situation to a customer representative in cases of suspicious/unstable speaker or ASR behavior. The latter is a typical feature of existing IVRs.

What is claimed is:

1. A system for creating pronunciation analysis-based speaker verification comprising of:
a speech recognition system that analyzes an utterance spoken by the user and returns a ranked list of recognized phrases;
a speech analysis module that analyzes a list of recognized phrases and determines the parts of utterances that were pronounced correctly and the parts of utterances that were mispronounced;
a star repository that contains star-like structures with the central node corresponding to a sequence of words or phonemes to be pronounced and the periphery nodes corresponding to results of ASR of pronunciation of the central node by a user or a group of users;
a star generation system that finds sequences of phonemes, words and phrases that have homogeneous N-best results in multiple occurrences in one utterance and across multiple utterances for a user or a group of users and stores the results in star repository;
a challenge phrase generation system that builds a set of phrases to be used to detect if a speaker is a legitimate user or an imposter using large corpora or internet at large to find phrases that correspond to stars that are consistently well recognized and stars that are consistently poorly recognized;
a speaker verification system that uses challenge phrases to verify that the phrases that are consistently well recognized for a user continue to be well recognized during verification/authentication of a speaker, and the ones that were consistently mispronounced by a user are mispronounced during verification/authentication phase; and
a human-machine interface that facilitates user registration and speaker verification phases.

2. The system of claim 1 where users' utterances are stored in an utterance repository accessible via the Internet.

3. The system of claim 1, further comprising a performance repository accessible via the Internet, wherein users' mispronunciations and speech peculiarities are stored corresponding to their types.

4. The system of claim 1, further comprising a speech analysis system that stores users' mispronunciations and speech peculiarities in a performance repository accessible via the Internet.

5. The system of claim 1, further comprising a star repository that contains stars consisting of central node containing a sequence of words or phonemes to be pronounced and periphery nodes corresponding to ASR results of central nodes pronounced by users.

6. The system of claim 1, further comprising of a star generation system that builds stars using an utterance repository and stores them in a star repository accessible via the Internet.

7. The system of claim 1, further comprising of a challenge phrase generation system that uses star repository and other data sources including internet at large to build phrases that will be stably recognized or stably misrecognized by ASR to be used to detect an imposter at the speaker verification phase, and storing these phrases in a challenge phrase repository available via the Internet.

8. The system of claim I, further comprising a verification system that offers to a speaker challenge phrases from a challenge repository and scores the results for verification based on comparing stable patterns (correct and incorrect) of a user and a speaker that is being verified.

9. The system of claim 1, wherein a speech recognition system is accessible via the Internet.

10. The system of claim 9, wherein a speech recognition system comprises a publicly available third-party speech recognition system.

11. The system of claim 1 wherein a human-machine interface is configured to operate on a mobile device.

12. A method for creating pronunciation analysis-based speaker verification comprising of: analyzing user utterances using a speech recognition system, the speech recognition system returning a ranked list of recognized phrases;
using the ranked lists of recognition results to build user's pronunciation profile consisting of user's mispronunciations and speech peculiarities organized by types;
using the Internet, large text corpora and other sources to build challenge phrases that match user pronunciation profile in correct and incorrect pronunciation that are consistently recognized or misrecognized by an ASR; and
using the built challenge phrases at the verification phase to detect if a speaker is a legitimate user or an imposter.

13. The method of claim 12, further comprising accessing a speech recognition system via the Internet.

14. The method of claim 13, wherein accessing a speech recognition system via the Internet comprises accessing a publicly available third-party speech recognition system.

15. The method of claim 12, wherein the communication with the user is performed using a mobile device.
